(19) United States
(12) Patent Application Publication
(10) Pub. No.: US 2026/0195842 A1
(43) Pub. Date: Jul. 9, 2026

(54) GROUP CATEGORIZING METHOD AND SYSTEM BASED ON DYNAMIC HYPERGRAPH CLUSTERING OF INDIVIDUAL MOBILITY PATTERNS

(71) Applicant: Beijing Univ Civil Engn & Architecture, Beijing (CN)

(72) Inventors: Xia ZHAO, Beijing (CN); Zhihong LI, Beijing (CN); Li ZHAO, Beijing (CN); Yimeng QIN, Beijing (CN); Jianfeng LIU, Beijing (CN)

(21) Appl. No.: 19/408,610

(22) Filed: Dec. 4, 2025

(30) Foreign Application Priority Data
Jan. 7, 2025 (CN) 202510023345.7

(51) Int. Cl. G06Q 50/40; G06N 3/0455; G06N 3/08

(52) U.S. Cl. CPC G06Q 50/40; G06N 3/0455; G06N 3/08

(57) ABSTRACT

A group categorizing method and system based on dynamic hypergraph clustering of individual mobility patterns are provided, relating to the field of transportation information engineering. The method includes: constructing an individual mobility pattern feature matrix under each time slice; constructing an individual mobility pattern hypergraph under each time slice, and modeling a complex “many-to-many” high-order association relationship among individual mobility patterns across all time slices; proposing a mobility pattern-based dynamic hypergraph clustering model to categorize an individual-associated group; and applying the proposed model to a series of empirical datasets for training and testing to validate that the model can achieve better group categorizing performance than a baseline model.

### CROSS-REFERENCE TO RELATED APPLICATION

This patent application claims the benefit and priority of Chinese Patent Application No. 202510023345.7, filed with the China National Intellectual Property Administration on Jan. 7, 2025, the disclosure of which is incorporated by reference herein in its entirety as part of the present application.

### TECHNICAL FIELD

The present disclosure relates to the technical field of transportation information engineering, and in particular to a group categorizing method and system based on dynamic hypergraph clustering of individual mobility patterns.

### BACKGROUND

Intelligent travel, also known as intelligent transportation, refers to the effective penetration and integration of conventional transportation industry with the Internet by virtue of technologies and concepts such as mobile Internet, cloud computing, big data and the Internet of Things (IoT). On this basis, it can also integrate real-time sensing analysis technologies for driving behavior to achieve dynamic navigation with multiple modes and standards for public travel, thereby improving travel efficiency.

Categorizing travel groups is an important strategy to achieve intelligent travel, which is conducive to better understanding of the needs and preferences of different user groups, thereby providing more personalized and customized services as well as providing more refined active management.

In the related art, categorizing is conducted generally from two angles of time and space, and then the group category is further inferred based on time and space. However, the categorizing method in the related art has a high false positive rate. For example, due to accident or other reasons, the travel time and travel space of an individual both meet a certain group, and the individual is categorized into the corresponding group, but in actual situation, the individual belongs to another group. This leads to inaccurate group categorization, which may further affect activities, such as the formulation of corresponding policy opinions and the development of marketing.

Public transit has become an increasingly popular choice for passengers due to its advantages of high capacity, speed, and cost-effectiveness, thereby driving the demand for intelligent public transit systems. Intelligent public transit refers to the effective integration and penetration of mobile internet, cloud computing, big data, and the Internet of Things (IoT) with traditional public transit passenger behaviors. This enables the public transit system to sense and analyze the spatiotemporal distribution characteristics of different types of passengers in real-time, generate customized train scheduling schemes for various passenger types, and achieve multi-modal, multi-standard dynamic travel services for the public, thereby enhancing travel comfort.

When traveling by public transit, passengers often exhibit diverse mobility patterns due to various travel purposes (e.g., commuting to work, leisure and entertainment) or social relationships (e.g., family ties, hometown connections, business collaborations). However, these mobility patterns are rarely incorporated into existing public transit scheduling systems. In contrast, current public transit systems primarily rely on historical statistical data and real-time monitoring of station passenger flow, using temporal (e.g., peak hours, off-peak hours) and spatial (e.g., distribution across rail stations) distribution characteristics as the basis for scheduling decisions. Nevertheless, this macro-level scheduling approach only supports coarse spatiotemporal allocation of train capacity. It fails to discern the distinct passenger categories formed by differences in mobility patterns within the passenger population or to account for the quantitative and spatiotemporal distribution characteristics of various passenger types. Consequently, it is unable to formulate more comfortable, precise, and dynamic public transit scheduling strategies, ultimately leading to an imbalance between supply and demand in scheduling and reduced passenger comfort.

Existing passenger categorization techniques generally classify passengers based on temporal and spatial dimensions and subsequently infer passenger categories using these two aspects. However, these existing techniques often result in high misclassification rate of passenger categorization result. For instance, an individual may be categorized into a specific group due to coincidental or other reasons causing their travel time and space to align with that group, while in reality, the individual belongs to another group. Such inaccuracies in passenger categorization can subsequently impact the development of corresponding policies and marketing activities.

Therefore, it is imperative to propose a more accurate method for passenger travel categorization to better understand the travel needs and preferences of different user groups, support the formulation of refined and personalized train scheduling schemes for public transit systems, and vigorously promote the development of intelligent public transit and proactive management services.

### SUMMARY

The present disclosure provides a group categorizing method and system based on dynamic hypergraph clustering of individual mobility patterns, which is used for solving the defects of inaccurate group categorization and high false positive rate in related technologies. In the solution provided by the present disclosure, travel records of an individual are clustered by constructing a hypergraph, so that the accuracy of group categorization is improved.

The present disclosure provides a group categorizing method based on dynamic hypergraph clustering of individual mobility patterns. The method includes:
acquiring a collection of historical travel records of N individuals, segmenting the collection in time dimension in units of days to obtain a collection of historical travel records of N individuals under T consecutive time slices, and extracting D-dimensional travel features for each individual to construct a mobility pattern feature matrix of the N individuals;
for any time slice, regarding each individual as a vertex to obtain N vertexes, regarding a neighborhood group of each individual as a hyperedge of a hypergraph to obtain a collection of N hyperedges, and constructing an individual mobility pattern hypergraph under each time slice;
constructing a mobility pattern-based dynamic hypergraph clustering model, which comprises: learning a deep representation of an individual mobility pattern by relying on a Transformer “encoding-decoding” structure; learning a deep representation of a neighborhood group mobility pattern in a local space by relying on a hypergraph convolutional network model;
fusing the deep representation of the individual mobility pattern and the deep representation of the neighborhood group mobility patterns by using an attention mechanism; capturing a change value of a hypergraph topological structure under an interaction of forward time propagation and backward time propagation by using a bidirectional hypergraph convolutional network; and dynamically updating a hypergraph structure to complete training and testing of the model; and
inputting a collection of historical travel records of M individuals into the mobility-pattern-based dynamic hypergraph clustering model, and performing instance verification for categorization of an individual-associated group.

According to the group categorizing method based on dynamic hypergraph clustering of individual mobility pattern, the extracting the D-dimensional travel features for each individual to construct the mobility pattern feature matrix of the N individuals includes:
for any time slice τ, extracting the D-dimensional travel features for each individual, constructing the mobility pattern feature matrix X_{τ}∈R^{N×D} of the N individuals, where

$$\begin{matrix}{X}_{τ} = \\ [ {x}_{τ , 1}^{1} , {x}_{τ , 2}^{2} , … , {x}_{τ , N}^{D} ] ,\end{matrix}$$

to obtain an individual mobility pattern feature matrix X={X₁, . . . , X_{τ}, . . . , X_{T}} under T consecutive time slices, where x_{τ,i}(1≤i≤N) is a mobility pattern feature expression of an i-^{th} individual under a τ-^{th} time slice.

According to the group categorizing method based on dynamic hypergraph clustering of individual mobility patterns, the constructing the individual mobility pattern hypergraph under each time slice includes:
for any time slice τ, regarding the N individuals as vertexes of the hypergraph to obtain N vertexes, measuring a similarity value of mobility patterns of any two individuals by using Euclidean distance; connecting two neighboring vertexes, and setting an inverse function of the Euclidean distance as a corresponding edge weight; and determining k individuals with most similar mobility patterns based on a principle that “the smaller the Euclidean distance, the more similar the mobility patterns”, and constructing an i-^{th} neighborhood group

$${ε}_{τ}^{i}$$

under the τ-^{th} time slice;
setting the neighborhood group as a hyperedge to obtain the collection of N hyperedges, which forms an initial categorizing result of the individual-associated group, and obtaining an individual mobility pattern hypergraph G_{τ}=(V_{τ},E_{τ},X_{τ},W_{τ},H_{τ}) under the τ-^{th} time slice, where V_{τ} is a collection of vertexes that represent all individuals, E_{τ} is a collection of hyperedges that represent the neighborhood group mobility pattern, X_{τ} is a collection of vertex attributes that represent the individual mobility pattern, W_{τ} is a collection of hyperedge weights that represent importance of the neighborhood group, ω(e) representing a weight of a hyperedge e is an element in W_{τ}, H_{τ} is an incidence matrix that represents a membership relationship between an individual and a group, where H_{τ}=[h(v,e)]_{τ}∈R^{N×N}, and h(v,e) represents a membership relationship between a vertex v and the hyperedge e;
the membership relationship between the vertex v and the hyperedge e is as follows:

$$h ( v , e ) = \{ \begin{matrix}1 , & if v ∈ e \\ 0 , & others\end{matrix} , \qquad ( 1 )$$

where in Equation (1), v F e denotes that the vertex is on the hyperedge, D_{τ,V}=[d(v)] is a degree matrix of the vertex v under the time slice τ, which is used to describe an importance of the vertex v in a hypergraph G_{τ} at a current moment, and d(v) is a sum of weights of all hyperedges connected to the vertex v, which is calculated from Equation (2):

$$d ( v ) = {\sum }_{e ∈ E} ω ( e ) h ( v , e ) , \qquad ( 2 )$$

where D_{τ,e}=[d(e)] is a degree matrix of a hyperedge e under the time slice τ, which is used to describe an importance of a hyperedge e in the hypergraph G_{τ} under the time slice τ, and d(e) is a total number of all the vertexes connected by the hyperedge e, which is calculated from Equation (3):

$$d ( e ) = {\sum }_{v ∈ V} h ( v , e ) . \qquad ( 3 )$$

According to the group categorizing method based on dynamic hypergraph clustering of individual mobility patterns, the constructing the mobility pattern-based dynamic hypergraph clustering model includes:
learning the deep representation of the individual mobility pattern by using a Transformer model;
learning the deep representation of the neighborhood group mobility pattern in the local space by using the hypergraph convolutional network model;
fusing the individual mobility pattern and the neighborhood group mobility pattern to perform dynamic hypergraph deep clustering; and
training and testing the mobility pattern-based dynamic hypergraph clustering model, to complete a dynamic group categorization.

According to the group categorizing method based on dynamic hypergraph clustering of individual mobility patterns, the learning the deep representation of the individual mobility pattern by using the Transformer model includes:
autonomously learning a deep representation C^{(l)} of the individual mobility pattern from an individual mobility pattern feature matrix X at an l-^{th} (1≤l≤L) convolutional layer through an operating principle of a multi-head attention mechanism of a built-in encoder of the Transformer model, where C^{(l)} is calculated from Equation (4):

$$\{ \begin{matrix}{C}^{( l )} = {σ}_{ReLU} ( Transformer ( {C}^{( l - 1 )} ) ) = LN ( dropout ( FeedForward ( {Res}^{( l )} ) + {Res}^{( l )} ) ) \\ FeedForward ( {Res}^{( l )} ) = max ( 0 , {Res}^{( l )} {U}_{1} + {b}_{1} ) {U}_{2} + {b}_{1} \\ {Res}^{( L )} = L N ( MultiHead ( {C}^{( L - 1 )} ) + {c}^{( 1 - 1 )} )\end{matrix} \qquad ( 4 )$$

where σ_{ReLU} is a linear activation function, when l=1, C^{(l-1)}=C⁰ is the individual mobility pattern feature matrix X, LN is a regularization operation of a convolutional layer, dropout is an operation of randomly pruning a fully-connected layer, FeedForward is a fully-connected network, Res^{(l)} is a residual unit of a decoder of the Transformer model, U₁ and U₂ are weight parameters to be trained of the model, b₁ and b₂ are bias values, and MultiHead is the multi-head attention mechanism;
by using a built-in decoder in the Transformer model, obtaining reconstructed \tilde{X} through processing of L convolutional layers, thereby completing a decoding operation;
minimizing an average reconstruction error [symbol] _{transformer} to obtain the deep representation of the individual mobility pattern which is closest to a real situation, where ∥⋅∥_{Fro} is F norm, the average reconstruction error is generated in a process of encoding and decoding, and an expression for the average reconstruction error [symbol] _{transformer} is shown in Equation (5):

$${ℒ}_{transformer} = \frac{1}{T} \frac{1}{N} {\sum }_{T} {\sum }_{N} {‖ {X}_{τ} - {X}_{τ} ‖}_{Fro}^{2} ; \qquad ( 5 )$$

for any time slice τ, calculating a true probability distribution that an individual i belongs to a category j according to a distribution situation of the feature matrix X_{τ} and a real group category to which each individual belongs in the feature matrix X_{τ} and then acquiring a probability distribution curve GT of individual mobility pattern categories under the time slice τ in a real scenario;
acquiring a probability distribution curve TR of individual mobility pattern categories predicted by the Transformer under the time slice τ based on a distribution situation of the deep representation C^{(L)} of the individual mobility pattern at an L-^{th} convolutional layer;
determining a cumulative error [symbol] _{GT-TR} of the probability distribution curve GT and the probability distribution curve TR across all time slices, and determining a group categorization error after temporal feature learning with the Transformer, where [symbol] _{GT-TR} is calculated from Equation (6):

$${ℒ}_{GT - TR} = KL ( GT ‖ TR ) = {\sum }_{τ} {\sum }_{i} {\sum }_{j} {GT}_{ij} log \frac{{GT}_{τ ij}}{{TR}_{τ ij}} , \qquad ( 6 )$$

where GT_{τij} refers to a probability that the individual i in the curve GT under the time slice τ belongs to the category j, TR_{τij} refers to a probability that the individual i in the curve TR under the time slice τ belongs to the category j, and KL is “Kullback-Leibler divergence” distribution curve.

According to the group categorizing method based on dynamic hypergraph clustering of individual mobility patterns, the learning the deep representation of the neighborhood group mobility pattern in the local space by using the hypergraph convolutional network model includes:
performing a hypergraph convolutional network operation based on the hypergraph G and an initial categorizing result of the individual-associated group, and capturing a local spatial topological change of the neighborhood group, where for an l-^{th} convolutional layer, a deep representation Z^{(l)} of the neighborhood group mobility pattern is calculated from Equation (7):

$${Z}^{( l )} = HGCN ( {G}_{τ} , {Z}^{( l - 1 )} , {σ}_{ReLU} ) = {σ}_{ReLU} ( {D}_{τ , v}^{- 1 / 2} {H}_{τ} {W}_{τ} {D}_{τ , v}^{- 1 / 2} {H}_{τ} {W}_{τ} {D}_{τ , e}^{- 1} {H}_{τ}^{Transponse} {D}_{τ , v}^{- 1 / 2} {Z}^{( l - 1 )} Θ ) \qquad ( 7 )$$

where Θ is a convolutional hyperparameter, when l=1, Z^{(l-1)}=Z⁰ is a feature matrix X, and H_{τ}^{Transponse} denotes a transposed matrix of H_{τ}.

According to the group categorizing method based on dynamic hypergraph clustering of individual mobility patterns, the fusing the individual mobility pattern and neighborhood group mobility pattern to perform dynamic hypergraph deep clustering includes:
concatenating the deep representation C^{(l)} of the individual mobility pattern and the deep representation Z^{(l)} of the neighborhood mobility pattern through Equation (8) to obtain a concatenation result CZ^{(l)} of C^{(l)} and Z^{(l)} at the l-^{th} convolutional layer, where CZ^{(l)}ₙ is a n-^{th} vector sequence of CZ^{(l)};
introducing an attention mechanism to obtain a new representation \tilde{Z}^{(l)} of the neighborhood group mobility pattern at the l-^{th} convolutional layer through Equation (9):

$${CZ}^{( 1 )} = {C}^{( l )} ⊕ {Z}^{( l )} , \qquad ( 8 )$$

$${\tilde{Z}}^{( 1 )} = Attention ( {CZ}^{( l )} , q ) = {\sum }_{n = 1}^{N} {α}_{n} {CZ}_{n}^{( l )} = {\sum }_{n = 1}^{N} \frac{exp ( s ( {CZ}_{n}^{( l )} , q ) )}{{\sum }_{n = 1}^{N} exp ( s ( {CZ}_{n}^{( l )} , q ) )} {CZ}_{n}^{( l )} , \qquad ( 9 )$$

where q is a query vector, αₙ is an attention weight of a n-^{th} element,

$${\sum }_{n = 1}^{N} {α}_{n} = 1 ,$$

s(CZ^{(l)}ₙ,q) is an attention scoring function, which is used to measure similarity between CZ^{(l)}ₙ and the query vector q, and is expressed quantitatively by a dot product model;
based on a distribution situation of \tilde{Z}^{(l)}, capturing a hypergraph topological structure change ΔG_{τ} he under the interaction of the forward time propagation and the backward time propagation, that is, the hypergraph topological structure change belonging to either the first hypergraph or the second hypergraph, but not belonging to both, which is calculated by Equation (10):

$$Δ {G}_{T} = difference ( {G}_{1 \to τ} , {G}_{T \to τ} ) = ( {G}_{1 \to τ} ⋃ {G}_{T \to τ} ) - ( {G}_{1 \to τ} ⋂ {G}_{T \to τ} ) \qquad ( 10 )$$

dynamically updating a corresponding hypergraph G_{τ} based on G_{τ} and ΔG_{τ}, which serves as an input of the hypergraph convolutional network at a convolutional layer l+1, and performing attention fusion with a corresponding output result C^{(l)} from Transformer at an (l+1)-^{th} layer, and executing a hypergraph convolutional network operation to obtain a probability distribution result \tilde{Z}^{(l+1)} of group categories at the (l+1)-^{th} to L-^{th} convolutional layers,

$${\tilde{Z}}^{( 1 + 1 )} = HGCN ( {G}_{T} ⊕ Δ {G}_{T} , {\tilde{Z}}^{( l )} , {σ}_{softmax} ) = {σ}_{softmax} ( {{D}^{′}}_{τ , v}^{- 1 / 2} {H}_{τ}^{′} {W}_{τ}^{′} {D}_{τ , e}^{′ - 1} {H}_{τ}^{′ Transponse} {D}_{τ , v}^{′ - 1 / 2} {\tilde{Z}}^{( l )} Θ ) where {W}_{τ}^{′} , {H}_{τ}^{′} , {D}_{τ , v}^{′} and {D}_{τ , e}^{′} , \qquad ( 11 )$$

are a collection of hyperedge weights, an incidence matrix, a vertex degree matrix and a hyperedge degree matrix of a dynamic hypergraph G_{τ}⊕ΔG_{τ}, respectively;
for any time slice τ, acquiring a probability distribution curve HC of the individual mobility pattern categories obtained by hypergraph clustering under the time slice τ based on the distribution situation of the deep representation Z^{(L)} of the individual mobility pattern at the l-^{th} convolutional layer, measuring a cumulation error [symbol] _{GT-HC} of the probability distribution curves HC and the curve GT across all time slices, and measuring a group categorization error of dynamic hypergraph depth clustering that integrates the individual mobility pattern and the neighborhood group mobility pattern, where [symbol] _{GT-HC} is calculated from Equation (12):

$${ℒ}_{GT - HC} = KL ( GT ‖ HC ) = {\sum }_{τ} {\sum }_{i} {\sum }_{j} {GT}_{ij} log \frac{{GT}_{τ ij}}{{HC}_{τ ij}} , \qquad ( 12 )$$

where HC_{τij} is a probability that the individual i in the curve HC under the time slice τ belongs to the category j.

According to the group categorizing method based on dynamic hypergraph clustering of individual mobility patterns, the training and testing the mobility pattern-based dynamic hypergraph clustering model to complete the dynamic group categorization includes:
calculating an overall error through the following Equation:

$$ℒ = {γ}_{1} {ℒ}_{Transformer} + {γ}_{2} {ℒ}_{GT - TR} + {γ}_{3} {ℒ}_{GT - HC} \qquad ( 13 )$$

where γ₁, γ₂ and γ₃ are weight coefficients of [symbol] _{transformer}, [symbol] _{GT-TR} and [symbol] _{GT-HC}, respectively;
training the mobility pattern-based dynamic hypergraph clustering model by relying on the feature matrix X of N individual mobility patterns under T time slices, minimizing a cumulative error [symbol] until [symbol] no longer changes to achieve model convergence, thereby completing the training of the model; and
inputting a feature matrix X_{T+1} of N individual mobility patterns under T+1 time slices into a trained model, and determining that the individual-associated group in a test dataset is found.

According to the group categorizing method based on dynamic hypergraph clustering of individual mobility patterns, after completing the training and testing of the model, the method further comprises performing instance verification for categorization of an individual-associated group, which specifically includes:
inputting a feature matrix

$${X}_{T}^{′}$$

of M individual mobility patterns under T time slices, and finding an individual-associated group in a verification dataset by using the group categorizing method; wherein the group categorizing method is applied to a public transportation passenger card tap-in and tap-out dataset, and the performance of the proposed method and an internal module thereof are verified by multi-group comparative experiment and ablation experiment.

The present disclosure further provides a group categorizing system based on dynamic hypergraph clustering of individual mobility patterns, including:
a data acquisition module, configured to acquire a collection of historical travel records of N individuals;
an individual mobility pattern feature matrix extraction module, configured to extract D-dimensional travel features from a historical travel record and to quantitatively express a mobility pattern of each individual;
an individual mobility pattern hypergraph collection construction module, configured to construct a collection of hypergraphs at a current period of time according to a feature matrix of current individual mobility patterns;
an individual mobility pattern deep representation learning module, configured to learn a deep representation of each individual mobility pattern relying on a Transformer “encoding-decoding” structure;
a neighborhood group mobility pattern deep representation learning module, configured to learn a deep representation of a neighborhood group mobility pattern in a local space relying on a hypergraph convolutional network model;
a dynamic hypergraph deep clustering module, configured to fuse the deep representation of the individual mobility pattern and the deep representation of the neighborhood group mobility pattern by using an attention mechanism, capture a change value of a hypergraph topological structure under an interaction of forward time propagation and backward time propagation by using a bidirectional hypergraph convolutional network, and update a hypergraph structure dynamically;
a training and testing module, configured to input the collection of historical travel records of N individuals into a mobility pattern-based dynamic hypergraph clustering model for performing training and testing on categorization of an individual-associated group; and
a verification module, configured to input a collection of historical travel records of M individuals into the mobility pattern-based dynamic hypergraph clustering model to perform instance validation of the categorization of the individual-associated group. According to the group categorizing method and system based on dynamic hypergraph clustering of individual mobility patterns provided by the present disclosure, a mobility pattern matrix and a mobility pattern hypergraph can be constructed based on a collection of travel records of individuals, where the constructed mobility pattern matrix can categorize individuals into different types from a temporal-spatial perspective of “one-way connection between two points”, while the mobility pattern hypergraph, on the basis of temporal-spatial categorizing criteria, can consider an implicit association relationship between individuals from a “many-to-many” perspective, and characterize groups with inherent association relationships through neighborhood groups in the hypergraph. The solution provided by the present disclosure can achieve accurate group categorization by accurately identifying a “many-to-many” association relationship in an individual travel mode.

The method provided by the present disclosure may be integrated into existing public transit dispatch system. By fine-grained categorization of passenger travel types and analyzing the quantitative, spatial, and temporal distribution characteristics of each group of passenger, it facilitates the development of more comfortable, precise, and dynamic public transit capacity scheduling schemes. This approach optimizes the alignment between public transit resource supply and passenger demand, thereby enhancing the travel comfort for all passenger categories.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a first flow diagram of a group categorizing method based on dynamic hypergraph clustering of individual mobility patterns according to an embodiment of the present disclosure;

FIG. 2 is a second flow diagram of a group categorizing method based on dynamic hypergraph clustering of individual mobility patterns according to an embodiment of the present disclosure;

FIG. 3 is a structural diagram of a group categorizing system based on dynamic hypergraph clustering of individual mobility patterns according to an embodiment of the present disclosure.

### DETAILED DESCRIPTION OF THE EMBODIMENTS

To make the objectives, the technical solutions and advantages of the present disclosure more clearly, the following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

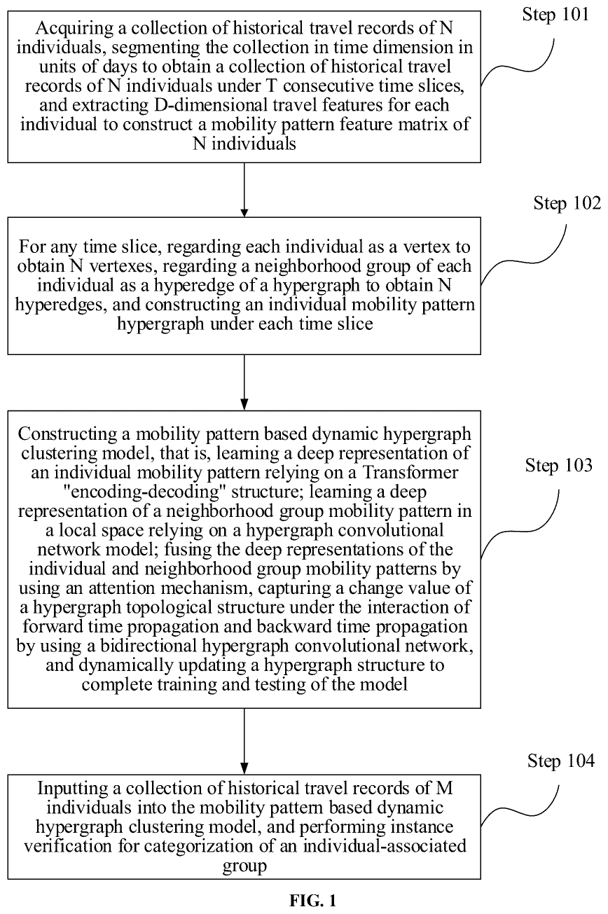

FIG. 1 is a first flow diagram of a group categorizing method based on dynamic hypergraph clustering of individual mobility patterns according to an embodiment of the present disclosure.

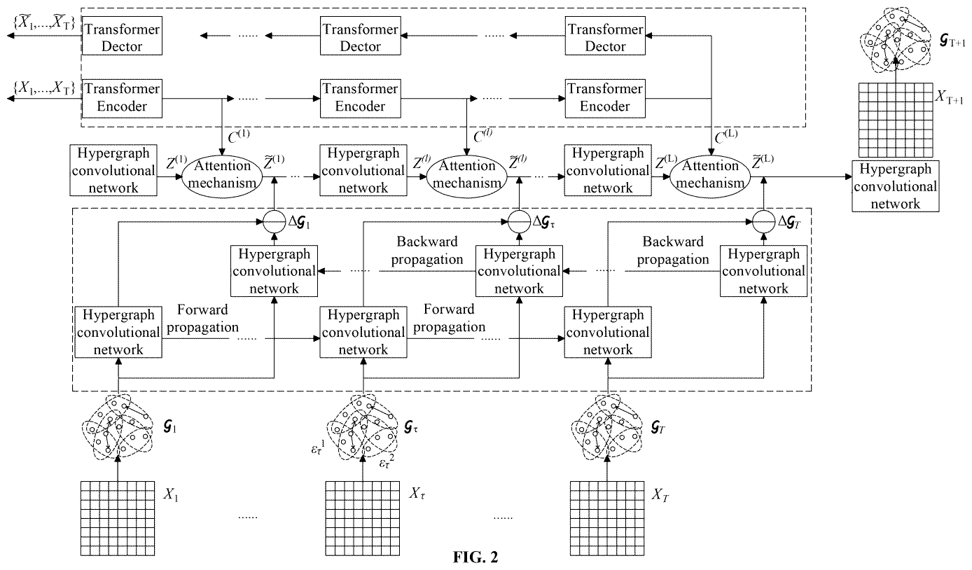

FIG. 2 is a second flow diagram of a group categorizing method based on dynamic hypergraph clustering of individual mobility patterns according to an embodiment of the present disclosure.

As shown in FIG. 1 and FIG. 2, this embodiment provides a group categorizing method based on dynamic hypergraph clustering of individual mobility patterns, including steps 101-104.

In step 101, a collection of historical travel records of N individuals is acquired, the collection is segmented in time dimension in units of days to obtain a collection of historical travel records of N individuals under T consecutive time slices, and D-dimensional travel features are extracted for each individual to construct a mobility pattern feature matrix of N individuals.

In step 102, for any time slice, each individual is regarded as a vertex to obtain N vertexes, a neighborhood group of each individual is regarded as a hyperedge of a hypergraph to obtain N hyperedges, and an individual mobility pattern hypergraph under each time slice is constructed.

In step 103, a mobility pattern-based dynamic hypergraph clustering model is constructed, that is, a deep representation of an individual mobility pattern is learned relying on a Transformer “encoding-decoding” structure; a deep representation of a neighborhood group mobility pattern in a local space is learned relying on a hypergraph convolutional network model; the deep representation of the individual mobility pattern and the deep representation of the neighborhood group mobility pattern are fused by using an attention mechanism, a change value of a hypergraph topological structure under the interaction of forward time propagation and backward time propagation is captured by using a bidirectional hypergraph convolutional network, and a hypergraph structure is dynamically updated to complete training and testing of the model.

In step 104, a collection of historical travel records of M individuals is input into the mobility pattern-based dynamic hypergraph clustering model, and instance verification for categorization of an individual-associated group is performed.

The individual may be a person. Further, the collection of travel records may include travel times and travel destinations of multiple travelers, or further include different means of transportation taken, as well as the time and location of boarding the transportation, the time and location of getting off the transportation, and the like.

In practical application, the foregoing collection of travel records may be acquired from a municipal transportation system, such as a public transportation database in Beijing.

In practical application, a N-row D-column matrix X=[x₁, x₂, . . . , x_{N}]∈R^{N×D} can be constructed, where xᵢ (i=1, 2, . . . , N) denotes an i-th individual, D-column means features in the collection of travel records corresponding to the individual, where the features in the collection of travel records may include degree, degree centrality, betweenness centrality, closeness centrality, feature vector centrality, and a clustering coefficient. The degree is the number of edges directly connected to a certain vertex (individual), which measures a basic indicator of the number of vertexes directly connected in a network and reflects basic connectivity of the vertex. The betweenness centrality measures the number of times that a vertex appears in all shortest paths and reflects the ability of the vertex to control information flow and resource flow, which is an important indicator for evaluating the importance of the vertex. The closeness centrality measures an average shortest path length from one vertex to all other vertexes in the network and reflects the reachability of the vertex in the network, which is an indicator for evaluating location superiority of the vertex in the network. The feature vector centrality considers not only the number of neighbors directly connected by the vertex but also the importance of neighbor vertexes and comprehensively reflects the influence of the vertex in the network, which is suitable for evaluating long-term importance of the vertex in the network. The clustering coefficient measures the degree of connection among neighboring vertexes of one vertex and reflects local connectivity of the network, which is of great significance for understanding a community structure of the network and a social environment of the vertex.

Hypergraph is a generalized graph structure. Compared with a conventional graph structure that one edge can only connect two vertices, one edge in the hypergraph structure can connect any number of vertices. The advantage of the hypergraph structure is its ability to distinguish hierarchical structures of information, and any complex information structure can be constructed using these two types of information.

In practical application, vertex and an edge weight of the hypergraph can be determined based on multiple selected individuals to construct an individual mobility pattern hypergraph Gₘ={V,E,W}, where V, E and W represent a vertex set, a hyperedge set and an edge weight set of the hypergraph, respectively, its incidence matrix is H=[h(v,e)]∈ [symbol] ^{N×N} an internal element h(v,e) of the incidence matrix characterizes a membership relationship between the vertex v and a hyperedge e, v∈e denotes that the vertex is on the hyperedge, Dᵥ and Dₑ are degree matrices of v and e, respectively, describing importance of any vertex or hyperedge in the hypergraph. For the vertex v E V in the hypergraph, the degree d(v) thereof is a sum of weights of all hyperedges connected to the vertex v, and a collection of d(v) forms a vertex degree matrix Dᵥ=[d(v)] of the hyperedge. For the hyperedge e∈E in the hypergraph, the degree d(e) thereof is a total number of all the vertexes connected by the edge e, and a collection of d(e) forms a hyperedge degree matrix Dₑ=[d(e)] of the hypergraph.

When many individuals complete a social activity together, the mobility patterns are similar. The individuals with similar mobility patterns may interact with each other, and the more similar the mobility patterns, the higher the degree of interaction between the individuals. Compared with the conventional graph structure that only describes the correlation between pairs of vertexes, the hypergraph aggregates interactive association information of multiple neighboring vertexes, which is more conducive to discovering potential modules in the graph and then modeling the association characteristics between multiple individuals. Based on this, the concept of hypergraph is introduced into the solution of this embodiment. By constructing the mobility pattern hypergraph of the individual, the complex “many-to-many” high-order association relationship among individual mobility patterns can be modeled.

In practical application, a deep representation of the mobility pattern matrix can be made based on the temporal feature learning with transformer. Specifically, the deep representation of the individual mobility pattern from the mobility pattern matrix at a convolutional layer can be learned by introducing a transformer model and using an operating principle of a multi-head attention mechanism of a built-in encoder of the transformer model.

Neighborhood is a topological structure on the collection, neighborhood is a special curve, and if a certain point is the center point, any open interval is called the neighborhood of the point.

In this embodiment, a hypergraph convolutional network (HGCN) operation can be performed to capture a local spatial topological change of the neighborhood group, and then for each convolutional layer of the hypergraph convolutional network, a deep representation of the neighborhood group can be determined, that is, the second representation.

Clustering is a process of dividing a collection of physical or abstract objects into similar object classes. A cluster is a collection of data objects. These objects are similar to those in the same cluster but different from those in other clusters.

According to the group categorizing method provided by the present disclosure, a mobility pattern matrix and a mobility pattern hypergraph can be constructed based on a collection of travel records of individuals, where the constructed mobility pattern matrix can categorize individuals into different types from a temporal-spatial perspective of “one-way connection between two points”, furthermore, the mobility pattern hypergraph, on the basis of temporal-spatial categorizing criteria, can consider an implicit association relationship between individuals from a “many-to-many” perspective, and characterize groups with inherent association relationships through neighborhood groups in the hypergraph. The solution provided by the present disclosure can achieve accurate group categorization by accurately identifying a “many-to-many” association relationship in an individual travel mode.

In an example embodiment, extracting D-dimensional travel features for each individual to construct a mobility pattern feature matrix of N individuals includes:
for any time slice τ, extracting D-dimensional travel features for each individual to construct a mobility pattern feature matrix X_{τ}∈R^{N×D} of N individuals, where

$${X}_{τ} = [ {x}_{τ , 1}^{1} , {x}_{τ , 2}^{2} , … , {x}_{τ , N}^{D} ] ,$$

and obtaining an individual mobility pattern feature matrix X={X₁, . . . , X_{τ}, . . . , X_{T}} under T consecutive time slices, where x_{τ,i}(1≤i≤N) is a mobility pattern feature expression of an i-^{th} individual under a τ-^{th} time slice.

In practical application, the acquired collection of travel records is definitely travel records within a long period of time. In fact, in the process of group categorization, this large-scale collection of travel records can be divided into several time slices according to time. In practice, the time slice may be in days. For example, the acquired collection of travel records may be a complete collection of a certain year or a certain month. For example, all the travel records of these individuals in August can be obtained and partitioned by days, such as, a collection of travel records on August 1^{st}, a collection of travel records on August 2^{nd}, and a collection of travel records on August 3^{rd}. A relatively long time span can be divided into small time spans by segmenting the collection of travel records in time dimension. In this embodiment, this way is used to implement group categorization in the time dimension.

After segmenting the collection of travel records of individuals in time dimension, a collection of historical travel records under multiple consecutive time slices can be obtained. Further, for each time slice, D-dimensional travel features can be extracted for each individual to construct a mobility pattern feature matrix X_{τ}∈R^{N×D} of N individuals, where

$${X}_{τ} = [ {x}_{τ , 1}^{1} , {x}_{τ , 2}^{2} , … , {x}_{τ , N}^{D} ] ,$$

thereby generating an individual mobility pattern feature matrix sequence X={X₁, . . . , X_{τ}, . . . , X_{T}} under T consecutive time slices, where x_{τ,i} (1≤i≤N) is a mobility pattern feature representation of an i-^{th} individual under a τ-^{th} time slice. An association network among individuals is modeled by a graph theory. For any time slice τ, each individual is regarded as a vertex on the graph. The connectivity between vertexes is connected by edges. An inverse function of Euclidean distance between the attributes of pairwise vertexes is taken as a corresponding edge weight.

Further, for any time slice τ, based on the principle that “the smaller the Euclidean distance, the more similar the mobility patterns”, k individuals with most similar mobility patterns are determined to construct an i-^{th} neighborhood group

$${ε}_{τ}^{i}$$

under the τ-^{th} time slice, thereby representing a complex “many-to-many” association relationship of k individuals in a specific time slice. By analogizing the foregoing neighborhood groups as hyperedges, a collection of N hyperedges can be obtained, which forms an initial categorizing result of the individual-associated group.

In an example embodiment, constructing the individual mobility pattern hypergraph under each time slice includes:

for any time slice τ, regarding N individuals as vertexes of the hypergraph to obtain N vertexes; measuring a similarity value of mobility patterns of any two individuals by using Euclidean distance; connecting two neighboring vertexes, and setting an inverse function of the Euclidean distance as a corresponding edge weight; and determining k individuals with most similar mobility patterns based on the principle that “the smaller the Euclidean distance, the more similar the mobility patterns”, and constructing an i-^{th} neighborhood group

$${ε}_{τ}^{i}$$

under the τ-^{th} time slice;
setting the neighborhood group as a hyperedge to obtain a collection of N hyperedges, which forms an initial categorizing result of the individual-associated group to obtain an individual mobility pattern hypergraph G_{τ}=(V_{τ},E_{τ},X_{τ},W_{τ},H_{τ}) under the τ-^{th} time slice, where V_{τ} is a collection of vertexes that represent all individuals, E_{τ} is a collection of hyperedges that represent the neighborhood group mobility pattern, X_{τ} is a collection of vertex attributes that represent the individual mobility pattern, W_{τ} is a collection of hyperedge weights that represent importance of the neighborhood group, ω(e) representing a weight of a hyperedge e is an element in W_{τ}, H_{τ} is an incidence matrix that represents a membership relationship between an individual and a group, where H_{τ}=[h(v,e)]_{τ}∈R^{N×N}, and h(v,e) represents a membership relationship between the vertex v and the hyperedge e;
the membership relationship between the vertex v and the hyperedge e is as follows:

$$h ( v , e ) = \{ \begin{matrix}1 , \\ 0 ,\end{matrix} \begin{matrix}if v ∈ e \\ others\end{matrix} , \qquad ( 1 )$$

where in Equation (1), v∈e denotes that a vertex is on a hyperedge, D_{τ,v}=[d(v)] is a degree matrix of the vertex v under the time slice τ, which is used to describe the importance of the vertex v in a hypergraph G_{τ} at current moment, and d(v) is a sum of weights of all hyperedges connected to the vertex v, which is calculated from Equation (2):

$$d ( v ) = {\sum }_{e ∈ E} ω ( e ) h ( v , e ) , \qquad ( 2 )$$

where D_{τ,e}=[d(e)] is a degree matrix of a hyperedge e under the time slice τ, which is used to describe the importance of a hyperedge e in the hypergraph G_{τ} under the time slice τ, and d(e) is the total number of all the vertexes connected by the hyperedge e, which is calculated from Equation (3):

$$d ( e ) = {\sum }_{v ∈ V} h ( v , e ) . \qquad ( 3 )$$

In an example embodiment, constructing the mobility pattern-based dynamic hypergraph clustering model includes:
learning the deep representation of the individual mobility pattern by using the Transformer model;
learning the deep representation of the neighborhood group mobility pattern in a local space by using the hypergraph convolutional network model;
fusing the individual mobility pattern and neighborhood group mobility pattern to perform dynamic hypergraph deep clustering;
training and testing the mobility pattern-based dynamic hypergraph clustering model.

In an example embodiment, learning the deep representation of the individual mobility pattern by using the Transformer model includes:

autonomously learning the deep representation C^{(l)} of the individual mobility pattern from the individual mobility pattern feature matrix X at the l-^{th} (1≤l≤L) convolutional layer through an operating principle of a multi-head attention mechanism of a built-in encoder of the Transformer model, where C^{(l)} is calculated from Equation (4):

$$\{ \begin{matrix}\begin{matrix}{C}^{( l )} = {σ}_{ReLU} ( Transformer ( {C}^{( l - 1 )} ) ) = \\ LN ( dropout ( FeedForward ( {Res}^{( l )} ) + {Res}^{( l )} ) )\end{matrix} \\ FeedForward ( {Res}^{( l )} ) = max ( 0 , {Res}^{( l )} {U}_{1} + {b}_{1} ) {U}_{2} + {b}_{1} \\ {Res}^{( l )} = L N ( MultiHead ( {C}^{( l - 1 )} ) + {C}^{( l - 1 )} )\end{matrix} ; \qquad ( 4 )$$

where σ_{ReLU} is a linear activation function, when l=1, C^{(l-1)}=C⁰ is the individual mobility pattern feature matrix X, LN is a regularization operation of a convolutional layer, dropout is an operation of randomly pruning a fully-connected layer, FeedForward is a fully-connected network, Res₍ₗ₎ is a residual unit of a decoder of the Transformer model, U₁ and U₂ are weight parameters to be trained of the model, b₁ and b₂ are bias values, and MultiHead is the multi-head attention mechanism;
by using a built-in decoder in the Transformer model, obtaining the reconstructed \tilde{X} through the processing of L convolutional layers, thereby completing a decoding operation;
minimizing an average reconstruction error [symbol] _{transformer} to obtain the deep representation of the individual mobility pattern which is closest to a real situation, where ∥⋅∥_{Fro} is F norm, the average reconstruction error is generated in the process of encoding and decoding, and an expression for the average reconstruction error [symbol] _{transformer} is shown in Equation (5):

$${ℒ}_{transformer} = \frac{1}{T} \frac{1}{N} {\sum }_{T} {\sum }_{N} {‖ {X}_{T} - \text{?} ‖}_{Fro}^{2} ; \qquad ( 5 )$$

for any time slice τ, calculating a true probability distribution that an individual i belongs to a category j according to a distribution situation of the feature matrix X_{τ} and a real group category to which each individual belongs in the feature matrix X_{τ}, and then acquiring a probability distribution curve GT of individual mobility pattern categories under the time slice τ in a real scenario;
acquiring a probability distribution curve TR of the individual mobility pattern categories predicted by the Transformer under the time slice τ based on a distribution situation of the deep representation C^{(L)} of the individual mobility pattern at an L-^{th} convolutional layer;
determining a cumulative error [symbol] _{GT-TR} of the probability distribution curve GT and the probability distribution curve TR across all time slices, and determining a group categorization error after temporal feature learning with Transformer, where [symbol] _{GT-TR} is calculated from Equation (6):

$${ℒ}_{G T - T R} = KL ( GT \vert \vert TR ) = {\sum }_{τ} {\sum }_{i} {\sum }_{j} {GT}_{ij} log \frac{G {T}_{τ ij}}{T {R}_{τ ij}} ; \qquad ( 6 )$$

where GT_{τij} refers to a probability that the individual i in the curve GT under the time slice τ belongs to the category j, TR_{τ} refers to a probability that the individual i in the curve TR under the time slice τ belongs to the category j, and KL is “Kullback-Leibler divergence” distribution curve.

In an example embodiment, learning the deep representation of the neighborhood group mobility pattern in the local space by using the hypergraph convolutional network model includes:

performing a hypergraph convolutional network operation based on the hypergraph G_{τ} and an initial categorizing result of the individual-associated group, and capturing a local spatial topological change of the neighborhood group, where for an l-^{th} convolutional layer, the deep representation Z^{(l)} of the neighborhood group mobility pattern is calculated from Equation (7):

$${Z}^{( l )} = H G C N ( {G}_{τ} , {Z}^{( l - 1 )} , {σ}_{ReLU} ) = {σ}_{ReLU} ( {D}_{τ , v}^{- 1 / 2} {H}_{τ} {W}_{τ} {D}_{τ , e}^{- 1} {H}_{τ}^{Transponse} {D}_{τ , v}^{- 1 / 2} {Z}^{( l - 1 )} Θ ) \qquad ( 7 )$$

where Θ is a convolutional hyperparameter, when l=1, Z^{(l-1)}=Z⁰ is a feature matrix X, and H_{τ}^{Transponse} denotes a transposed matrix of H_{τ}.

In an example embodiment, fusing the individual mobility pattern and neighborhood group mobility pattern to perform dynamic hypergraph deep clustering includes:
concatenating the deep representation C^{(l)} of the individual mobility pattern and the deep representation Z^{(l)} of the neighborhood mobility pattern through Equation (8) to obtain a concatenation result CZ^{(l)} of C^{(l)} and Z^{(l)} at the l-^{th} convolutional layer, where CZ^{(l)}n is a n-^{th} vector sequence of CZ^{(l)};
Introducing an attention mechanism to obtain a new representation \tilde{Z}^{(l)} of the neighborhood group mobility pattern at the l-^{th} convolutional layer through Equation (9):

$${CZ}^{( l )} = {C}^{( l )} ⊕ {Z}^{( l )} ; \qquad ( 8 )$$

$${\tilde{Z}}^{( l )} = Attention ( {CZ}^{( l )} , q ) = {\sum }_{n = 1}^{N} {α}_{n} C {Z}^{{( l )}_{n}} = {\sum }_{n = 1}^{N} \frac{exp ( s ( C {Z}^{{( l )}_{n}} , q ) )}{{\sum }_{n = 1}^{N ( 1 )} exp ( s ( C {Z}^{{( l )}_{n}} , q ) )} C {Z}^{{( l )}_{n}} ; \qquad ( 9 )$$

where q is a query vector, αₙ is an attention weight of a n-^{th} element,

$${\sum }_{n = 1}^{N} {α}_{n} = 1 ,$$

s(CZ^{(l)}n,q) is an attention scoring function, which is used to measure similarity between CZ^{(l)} and the query vector q, and is expressed quantitatively by a dot product model;
based on a distribution situation of \tilde{Z}^{(l)}, capturing a hypergraph topological structure change ΔG_{τ} under the interaction of the forward time propagation and the backward time propagation, that is, the hypergraph topological structure change belonging to either the first hypergraph or the second hypergraph, but not belonging to both, which may be calculated by Equation (10):

$$Δ {G}_{T} = difference ( {G}_{1 \to τ} , {G}_{T \to τ} ) = ( {G}_{1 \to τ} ⋃ {G}_{T \to τ} ) - ( {G}_{1 \to τ} ⋂ {G}_{T \to τ} ) ; \qquad ( 10 )$$

dynamically updating the corresponding hypergraph G_{τ} based on G_{τ} and ΔG_{τ}, which serves as an input of the hypergraph convolutional network at a convolutional layer l+1, and performing attention fusion with a corresponding output result C^{(l+1)} from Transformer at the (l+1)-^{th} layer, and executing a hypergraph convolutional network operation to obtain probability distribution results \tilde{Z}^{(l+1)} of group categories at the (l+1)-^{th} to L-^{th} convolutional layers,

$${\tilde{Z}}^{( l + 1 )} = H G C N ( {G}_{τ} ⊕ Δ {G}_{τ} , {\tilde{Z}}^{( l )} , {σ}_{softmax} ) = {σ}_{softmax} ( {D}_{τ , v}^{′ - 1 / 2} {H}_{τ}^{′} {W}_{τ}^{′} {D}_{τ , e}^{′ - 1} {H}_{τ}^{′ Tramsponse} {D}_{τ , v}^{′ - 1 / 2} {\tilde{Z}}^{( l )} Θ ) \qquad ( 11 )$$

$$where {W}_{τ}^{′} , {H}_{τ}^{′} , {D}_{τ , e}^{′} and {D}_{τ , e}^{′} ;$$

are a collection of hyperedge weights, an incidence matrix, a vertex degree matrix and a hyperedge degree matrix of a dynamic hypergraph G_{τ}⊕ΔG_{τ}; respectively;
for any time slice τ, acquiring a probability distribution curve HC of the individual mobility pattern categories obtained by hypergraph clustering under the time slice τ based on the distribution situation of the deep representation Z^{(L)} of the individual mobility pattern at the l-^{th} convolutional layer, measuring a cumulation error L_{GT-HC} of the probability distribution curves HC and the curve GT across all time slices, and measuring a group categorization error of dynamic hypergraph depth clustering that integrates individual mobility pattern and neighborhood group mobility pattern, where [symbol] _{GT-HC} is calculated from Equation (12):

$${ℒ}_{G T - H C} = KL ( GT \vert \vert HC ) = {\sum }_{τ} {\sum }_{i} {\sum }_{j} {GT}_{ij} log \frac{G {T}_{τ ij}}{H {C}_{τ ij}} , \qquad ( 12 )$$

where HC_{τij} is a probability that the individual i in the curve HC under the time slice τ belongs to the category j.

In an example embodiment, training and testing the mobility pattern-based dynamic hypergraph clustering model includes:

calculating an overall error through the following Equation:

$$ℒ = {γ}_{1} {ℒ}_{transformer} + {γ}_{2} {ℒ}_{G T - T R} + {γ}_{3} {ℒ}_{G T - H C} , \qquad ( 13 )$$

where γ₁, γ₂ and γ₃ are weight coefficients of [symbol] _{transformer}, [symbol] _{GT-TR} and [symbol] _{GT-HC}, respectively;
training the mobility pattern-based dynamic hypergraph clustering model relying on the feature matrix X of N individual mobility patterns under T time slices, minimizing a cumulative error [symbol] until [symbol] no longer changes to achieve model convergence to complete the training of the model;
inputting a feature matrix X_{T+1} of N individual mobility patterns under T+1 time slices into the trained model, and determining the individual-associated group in a test dataset is found.

In an example embodiment, after completing the training and testing of the model, the method further includes performing instance verification for categorization of an individual-associated group, which includes:
inputting a feature matrix

$${X}_{T}^{′}$$

of M individual mobility patterns under T time slices, and finding an individual-associated group in a verification dataset by using a method established by the method; where the method is applied to a public transportation passenger card tap-in and tap-out dataset, and the performance of the proposed method and an internal module thereof are verified by multi-group comparative experiment and ablation experiment.

Below is a specific example to illustrate the group categorization method provided by the solution of the present disclosure, and a method for scheduling public transport capacity based on the results of group categorization upon the group categorization method being integrated into a public transit dispatch system, so as to support the development of more comfortable, precise, and dynamic dispatching schemes for public transit capacity allocation.

### (1) Operating Environment

Model codes are written by applying PyTorch framework. All experimental codes are compiled and executed in Linux software environment, and run on a hardware workstation equipped with “Intel® Xeon® CPU E5-2620V4 @2.10 GHz” central processing unit (CPU) and “NVIDIA P10016G Tesla” graphic processing unit (GPU) graphics card.

### (2) Introduction of Experimental Dataset

The experimental dataset of the present disclosure is a public transportation passenger card tap-in and tap-out dataset in a certain place, and a transaction period is August 2019, where the dataset includes 790,000 travel records generated by 13,962 individuals. The present disclosure obtains a group category of 2,792 individuals (20%) in advance. Among them, the first category includes 848 individuals with highly regular travel time and spatial patterns, primarily consisting of commuters; the second category includes 690 individuals with regular travel timing but irregular spatial patterns, primarily consisting of office workers with non-fixed workplaces; the third category includes 724 individuals with irregular travel timing yet regular spatial patterns, primarily consisting of commuters with irregular working hours; and the fourth category includes 530 individuals with both irregular travel time and spatial patterns, often primarily consisting of delivery personnel, domestic helpers, repair technicians, and the like. The travel features of these groups form a label matrix to verify the performance of group categorization results.

### (3) Selection of Benchmark Model

In a comparative and ablation experiment link, seven benchmark models are selected to compare with the proposed model on a given dataset.

K-means clustering model is one of unsupervised learning methods, which can find a hidden structure in the data by dividing observation points in the dataset into different groups or clusters;
Autoencoder (AE): input data is mapped by a built-in encoder to a low-dimensional potential space, and then a clustering task is performed in this space.

Improved deep embedded clustering model (IDEC) is improved from deep embedded clustering, original high-dimensional features are mapped to a low-dimensional space by using a pre-trained autoencoder weight, and the clustering task is executed in this space when the partial structure is maintained.

Structured deep clustering network (SDCN): a k-nearest neighbor graph based on feature similarity is constructed to perform autoencoder pre-training to capture an aggregation structure relationship between data.

Attention-driven graph clustering network (AGCN): multi-scale vertex attributes and graph topological feature information are extracted and dynamically fused to execute a data clustering task.

Cross-attention Fusion based Enhanced Graph Convolutional Network (CaEGCN): through a deep clustering framework with cross-attention, an autoencoder module and a graph convolution module are integrated to aggregate heterogeneous data.

Robust Graph Convolutional Clustering (RGCC): combined with a clustering algorithm of a graph convolutional neural network, the number of clusters does not need to be known in advance; instead, clustering is achieved by a graph convolutional neural network through global optimization of continuous objectives and dimensionality reduction.

### (4) Experimental Parameter Setting

“Adam W” optimizer is used to conduct 200 iterative trainings on a given dataset to develop performance study experiment on group categorizing. Learning rates of all models are set to be 10-4. To ensure a fair comparison of all methods, the present disclosure selects recommended network configuration parameters according to each baseline model for optimal setting. For K-means, 11 repeated calculation algorithms are performed to obtain an optimal clustering result. The network sizes of AE and IEDC are set to “500-500-2000-10-2000-500-500”. The network sizes of a GCN module and a built-in encoder in SDCN are both set to “500-500-2000-10”. The network sizes of built-in Cross AutoEnconder (CAE) and Graph AutoEnconder (GAE) modules in CaEGCN are configured as “500-10-500-500”. For the method provided in the present disclosure, weight coefficients γ₁, γ₂ and γ₃ in Equation 11 are respectively set to 1, 0.1 and 0.01. The built-in AE and Hypergraph Convolutional Network (HGCN) in the proposed method have a four-layer network structure, which are set to 500, 500, 2000 and 10, respectively. The total number of iterative trainings is 200.

### (5) Selection of Evaluation Indicator

The clustering performance of each model is evaluated through four common indexes, namely, accuracy (ACC), normalized mutual information (NMI), average rand indicator (ARI) and F1-score (F1). In general, the greater the evaluation indicator, the greater the effect.

### (6) Experiment Result and Analysis

Table 1 shows comparative experimental results of various models on a public transportation passenger card tap-in and tap-out dataset from in a certain place. In general, the proposed method achieves the best clustering performance (see data in the last row in Table 1).

Compared with a baseline model RGCC with the second best group categorizing performance, the proposed method has achieved rapid growth in all indicators, namely, ACC is increased by 4.59%, NMI is increased by 0.57%, ARI is increased by 2.49% and F1 is increased by 4.82%, which proves that the method has good group categorizing performance. This is due to the fact that the proposed method has a hypergraph module and a feature fusion module. The former can fully learn the similarity of deep mobility patterns between individuals and between neighborhood groups. The latter can effectively combine mobility pattern characteristics of individuals and their neighborhood groups, better describe implicit clustering characteristics of a target individual, and then improve the performance of group categorizing.

TABLE 1
Comparative experimental results of various models
on a public transportation passenger
card tap-in and tap-out dataset in a certain place

| Method | ACC | NMI | ARI | F1 |
|---|---|---|---|---|
| k-means | 72.44 | 65.90 | 56.85 | 58.25 |
| AE | 74.39 | 70.96 | 65.67 | 61.03 |
| IDEC | 84.04 | 80.81 | 80.38 | 70.45 |
| SDCN | 88.35 | 82.14 | 82.72 | 79.26 |
| AGCN | 88.91 | 85.10 | 84.60 | 87.20 |
| CaEGCN | 88.87 | 85.06 | 84.64 | 87.17 |
| RGCC | 90.12 | 85.54 | 85.16 | 89.04 |
| Proposed method | 94.71 | 86.11 | 87.65 | 93.86 |

Table 2 reflects improvement in group categorizing performance achieved by the hypergraph module and feature fusion module of the proposed method. The data in the second row of the table is a distribution situation of group categorizing performance when the proposed method only carries the hypergraph module. The data in the third row of the table is a distribution situation of the group categorizing performance when the proposed method carries the above two modules, i.e., the hypergraph module and feature fusion module. As can be learned from the table that adding hypergraph module can increase ACC by 1.93%, NMI by 2.08%, ARI by 4.11% and F1 by 1.90% of the proposed model, which proves that the hypergraph module can effectively explain the complex many-to-many association characteristics among individuals. After further adding the feature fusion module, the proposed model can increase ACC by 2.57%, NMI by 4.81%, ARI by 6.99% and F1 by 1.48% on the basis of adding the hypergraph module. This fully shows that both the hypergraph module and the feature fusion module designed by the present disclosure are helpful to improve the accurate group categorizing performance.

TABLE 2
Ablation experimental results of built-in modules
of proposed method on a public transportation passenger
card tap-in and tap-out dataset in a certain place

| Hypergraph | Feature | | | | |
|---|---|---|---|---|---|
| structure | fusion | ACC | NMI | ARI | F1 |
| X | X | 90.21 | 79.22 | 76.55 | 90.48 |
| √ | X | 92.14 | 81.30 | 80.66 | 92.38 |
| √ | √ | 94.71 | 86.11 | 87.65 | 93.86 |

Next, the group categorization system provided by the present invention will be described, and the group categorization system described below and the group categorization method described above can refer to each other correspondingly.

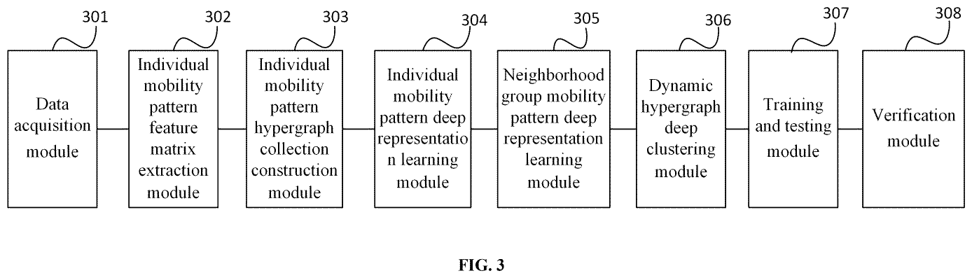

FIG. 3 is a structural diagram of a group categorizing system based on dynamic hypergraph clustering of mobility patterns according to an embodiment of the present disclosure.

As shown in FIG. 3, a group categorizing system based on dynamic hypergraph clustering of mobility patterns provided by this embodiment includes:
a data acquisition module 301, configured to acquire a collection of historical travel records of N individuals;
an individual mobility pattern feature matrix extraction module 302, configured to extract D-dimensional travel features from a historical travel record and to quantitatively express a mobility pattern of each individual;
an individual mobility pattern hypergraph collection construction module 303, configured to construct a collection of hypergraphs at a current period of time according to a feature matrix of current individual mobility patterns;
an individual mobility pattern deep representation learning module 304, configured to learn a deep representation of the individual mobility pattern relying on a Transformer “encoding-decoding” structure;
a neighborhood group mobility pattern deep representation learning module 305, configured to learn a deep representation of a neighborhood group mobility pattern in a local space relying on a hypergraph convolutional network model;
a dynamic hypergraph deep clustering module 306, configured to fuse the deep representation of the individual mobility pattern and the deep representation of the neighborhood group mobility pattern by using an attention mechanism, to capture a change value of a hypergraph topological structure under the interaction of forward time propagation and backward time propagation by using a bidirectional hypergraph convolutional network, and to update a hypergraph structure dynamically;
a training and testing module 307, configured to input the collection of historical travel records of N individuals into a mobility pattern-based dynamic hypergraph clustering model for performing training and testing on categorization of an individual-associated group; and
a verification module 308, configured to input a collection of historical travel records of M individuals into the mobility pattern-based dynamic hypergraph clustering model to perform instance validation of categorization of the individual-associated group.

This embodiment further embeds the group categorization system into a public dispatching system to finely identify four types of passenger travel groups: a group with regular travel times and regular origins and destinations (such as commuters with regular travel times and regular origins and destinations), a group with regular travel times but irregular origins and destinations (such as commuters with regular travel times but irregular origins and destinations), a group with irregular travel times but regular origins and destinations (such as flexible workers), and a group with irregular travel times and irregular origins and destinations (such as “mobile service personnel”). By summarizing the mobility patterns and travel demand differences among these groups and analyzing their quantitative, spatial, and temporal distribution characteristics, the public system can leverage historical station passenger flow data across different time periods (e.g., peak/off-peak hours), spatial distributions (e.g., station passenger flow at each station along a public transport route), and travel group to which travelers attributes (e.g., commuters, flexible workers, mobile service personnel) to implement the following four differentiated, dynamic, and customized measures for capacity allocation and carriage resource adjustment, ultimately improving the rationality of public resource supply-demand balance and enhancing travel comfort for all travelers.

For individuals or travelers in the group with regular travel times and regular origins and destinations, based on the proportion of travelers appearing at respective stations during respective periods among the total number of travelers (e.g., M individuals), “limited-stop express services” are deployed during extreme peak hours and fixed intervals in addition to the baseline schedules. Specifically, for the individuals in the group with regular travel times and regular origins and destinations among the M individuals, the proportion of the individuals appearing at respective stations during respective periods among the M individuals is calculated based on the collection of historical travel records; a target period during and a target station at which the proportion exceeds a predetermined proportion are identified; a deployment of public transport vehicle are increased on the basis of existing baseline schedules to allow deployed public transport vehicles to stop only at the target station during the target period. This prioritizes their rapid commuting needs and alleviates congestion on core segments.

For individuals or travelers in the group with regular travel times and irregular origins and destinations, based on the or travelers real-time identified origin-destination (OD) distribution of travelers in this group, the routes of some public transport vehicles (including the stations by which the vehicles pass and stations at which the vehicles stop) are dynamically adjusted, and some public transport vehicles are reallocated from idle routes to busy routes, so that the number of transfers and travel time for travelers in this group is reduced. Specifically, for the individuals in the group with regular travel times and irregular origins and destinations among the M individuals, historical public transportation card tap-in and tap-out data of the individuals is obtained; an origin-destination distribution of the individuals during respective time periods is determined from the historical public transportation card tap-in and tap-out data; based on the origin-destination distribution, a first time period and a first public transport route in which route passenger flow during the first time period drops below its historical average route passenger flow by more than a first flow threshold are determined (for example, the route passenger flow of public transport route A during the first time period is less than 20% of its historical average route passenger flow); a second time period and a second public transport route in which a route passenger flow during the second time period exceeds its historical average route passenger flow by more than a second flow threshold are determined (for example, the route passenger flow of public transport route B during the second time period is greater than 90% of its historical average route passenger flow); and at least one public transport vehicle is allocated from the first public transport route to the second public transport route during overlapping period of the first time period and second time period; where a route passenger flow of a public transport route is a sum of station passenger flows at all stations along the public transport route, for example, if a public transport route has three stations, such as Station 1, Station 2, and Station 3, then the route passenger flow of this route is the sum of the station passenger flow at Station 1, the station passenger flow at Station 2, and the station passenger flow at Station 3. In addition, station passenger flow refers to the number of people entering a station per unit of time.

For individuals or travelers in the group with irregular travel times but regular origins and destinations, the mobility pattern-based dynamic hypergraph clustering model may be utilized to predict minor travel peaks of this group. Temporary service frequency is increased during these predicted periods to prevent comfort degradation caused by sudden traveler gatherings and ensure spatiotemporal reliability of their trips. Specifically, for individuals in the group with irregular travel times and regular origins and destinations among the M individuals, a period, an origin, and a destination such that the route passenger flow from the origin to the destination during the period exceeds a third flow threshold are predicted by using a prediction model (e.g., the mobility pattern-based dynamic hypergraph clustering model with prediction function), and a service frequency of public transport between the origin and the destination is increased during the period.

For individuals or travelers in the group with irregular travel times and irregular origins and destinations, the system monitors sudden gatherings of travelers in the group in real-time, such as abnormal gatherings caused by special events like concerts and sports competitions. Upon detecting abnormal gatherings, a “dynamic capacity response” is triggered immediately, to allocate more individual transportation vehicles (such as taxis and ride-hailing cars) from the reserve pool to the vicinity of the gathering area, so as to operate temporary short-distance shuttle or direct services for rapid dispersal, preventing disruption to regular commuting services. Specifically, for individuals in the group with irregular travel times and irregular origins and destinations among the M individuals, a gathering area is determined based on a schedule of an event that causes gathering in combination with public transportation card tap-in and tap-out data of the individuals; and, in response to a number of the individuals gathering in the gathering area exceeding a predetermined number, individual transport vehicles are dispatched to an vicinity of the gathering area.

In conjunction with the above examples, it can be determined that the group categorization method provided by this application has at least the following beneficial effects.
(1) Deep representation characteristics of mobility patterns of individuals and their neighborhood groups are captured, and deep association learning and dynamic clustering are performed by using a hypergraph convolutional network to achieve accurate group categorization and improve the accuracy and robustness of group categorizing.
(2) This method effectively serves the field of public space traffic safety supervision, providing crucial theoretical reference for rationally regulating transportation supply-demand imbalances, efficiently allocating urban passenger transport resources, precisely managing crowd flow in congested areas, ensuring safe operation of urban transportation systems, and significantly enhancing public travel efficiency. It is expected to provide more refined group categorizing solutions for fields such as urban transportation planning, social media analysis, and disease transmission prediction, thereby promoting the development and progress of related fields.

From the description of the above embodiments, those skilled in the art can clearly understand that various embodiments can be implemented by means of software and necessary general hardware platform, and certainly, it may also be implemented by hardware. Based on this understanding, the essence of the foregoing technical solution or the part that has contributed to the prior art can be embodied in the form of a software product. The computer software product can be stored in a computer-readable storage medium, such as Read-only memory/Random-access memory (ROM/RAM), a magnetic disk, an optical disk, and the like, and includes several instructions to make a computer device (which may be a personal computer, a server, or a network device) execute various embodiments or methods of some parts of embodiments.

The foregoing embodiments are merely used to describe the technical solution of the present disclosure, rather than limitation. Although the present disclosure is described in detail with reference to the foregoing embodiments, a person of ordinary skill in the art should understand that: the technical solutions described in the foregoing embodiments may still be modified, or some technical features thereof may be equivalently replaced. These modifications or replacements shall not cause the essential nature of the corresponding technical solution to deviate from the spirit and scope of the technical solutions in the embodiments of the present disclosure.

What is claimed is:

1. A group categorizing method based on dynamic hypergraph clustering of individual mobility patterns, comprising:
acquiring a collection of historical travel records of N individuals, segmenting the collection in time dimension in units of days to obtain a collection of historical travel records of N individuals under T consecutive time slices, and extracting D-dimensional travel features for each individual to construct a mobility pattern feature matrix of the N individuals;
for any time slice, regarding each individual as a vertex to obtain N vertexes, regarding a neighborhood group of each individual as a hyperedge of a hypergraph to obtain a collection of N hyperedges, and constructing an individual mobility pattern hypergraph under each time slice;
constructing a mobility pattern-based dynamic hypergraph clustering model, which comprises: learning a deep representation of an individual mobility pattern by relying on a Transformer “encoding-decoding” structure; learning a deep representation of a neighborhood group mobility pattern in a local space by relying on a hypergraph convolutional network model; fusing the deep representation of the individual mobility pattern and the deep representation of the neighborhood group mobility pattern by using an attention mechanism; capturing a change value of a hypergraph topological structure under an interaction of forward time propagation and backward time propagation by using a bidirectional hypergraph convolutional network; and dynamically updating a hypergraph structure to complete training and testing of the model; and
inputting a collection of historical travel records of M individuals into the mobility pattern-based dynamic hypergraph clustering model, to obtain travel groups to which the M individuals belong; wherein the travel groups comprise: a group with regular travel times and regular origins and destinations, a group with regular travel times and irregular origins and destinations, a group with irregular travel times and regular origins and destinations, and a group with irregular travel times and irregular origins and destinations;
for first individuals in the group with regular travel times and regular origins and destinations among the M individuals, calculating a proportion of the first individuals appearing at respective stations during respective periods among the M individuals based on the collection of historical travel records; identifying a target period during and a target station at which the proportion exceeds a predetermined proportion; increasing a number of public transport vehicles on a basis of existing baseline schedules to allow increased public transport vehicles to stop only at the target station during the target period;
for second individuals in the group with regular travel times and irregular origins and destinations among the M individuals, obtaining historical public transportation card tap-in and tap-out data of the second individuals; determining an origin-destination distribution of the second individuals during respective time periods from the historical public transportation card tap-in and tap-out data; based on the origin-destination distribution, determining a first time period and a first public transport route in which a route passenger flow during the first time period drops below its historical average route passenger flow by more than a first flow threshold; determining a second time period and a second public transport route in which a route passenger flow during the second time period exceeds its historical average route passenger flow by more than a second flow threshold; and allocating at least one public transport vehicle from the first public transport route to the second public transport route during an overlapping period of the first time period and second time period; wherein a route passenger flow of a public transport route is a sum of station passenger flows at all stations along the public transport route;
for third individuals in the group with irregular travel times and regular origins and destinations among the M individuals, predicting a period, an origin and a destination such that route passenger flow from the origin to the destination during the period exceeds a third flow threshold; increasing a service frequency of public transport between the origin and the destination during the period; and
for fourth individuals in the group with irregular travel times and irregular origins and destinations among the M individuals, determining a gathering area based on a schedule of an event that causes gathering in combination with public transportation card tap-in and tap-out data of the fourth individuals; in response to a number of the fourth individuals gathering in the gathering area exceeding a predetermined number, dispatching individual transport vehicles to an vicinity of the gathering area.

2. The group categorizing method based on dynamic hypergraph clustering of individual mobility patterns according to claim 1, wherein the extracting the D-dimensional travel features for each individual to construct the mobility pattern feature matrix of the N individuals comprises:
for any time slice τ, extracting the D-dimensional travel features for each individual, constructing the mobility pattern feature matrix X_{τ}∈R^{N×D} of the N individuals,
$${x}_{τ} = [ {x}_{τ , 1}^{1} , {x}_{τ , 2}^{2} , … , {x}_{τ , N}^{D} ] ,$$
to obtain an individual mobility pattern feature matrix X={X₁, . . . , X_{τ}, . . . , X_{T}} under T consecutive time slices, wherein x_{τ,i} (1≤i≤N) is a mobility pattern feature expression of an i-^{th} individual under a τ-^{th} time slice.

3. The group categorizing method based on dynamic hypergraph clustering of individual mobility patterns according to claim 1, wherein the constructing the individual mobility pattern hypergraph under each time slice comprises:
for any time slice τ, regarding the N individuals as vertexes of the hypergraph to obtain N vertexes, measuring a similarity value of mobility patterns of any two individuals by using Euclidean distance; connecting two neighboring vertexes, and setting an inverse function of the Euclidean distance as a corresponding edge weight; and determining k individuals with most similar mobility patterns based on a principle that “as the Euclidean distance decreases, the similarity value of the mobility patterns increases”, and constructing an i-^{th} neighborhood group
$${ε}_{τ}^{i}$$
under a τ-^{th} time slice;
setting the neighborhood group as a hyperedge to obtain the collection of N hyperedges, which forms an initial categorizing result of the individual-associated group, and obtaining the individual mobility pattern hypergraph G_{τ}=(V_{τ},E_{τ},X_{τ},W_{τ},H_{τ}) under the τ-^{th} time slice, where V_{τ} is a collection of vertexes that represent all individuals, E_{τ} is a collection of hyperedges that represent the neighborhood group mobility pattern, X_{τ} is a collection of vertex attributes that represent the individual mobility pattern, W_{τ} is a collection of hyperedge weights that represent importance of the neighborhood group, ω(e) representing a weight of a hyperedge e is an element in W_{τ}, H_{τ} is an incidence matrix that represents a membership relationship between an individual and a group, wherein H_{τ}=[h(v,e)]_{τ}∈R^{N×N}, and h(v,e) represents a membership relationship between a vertex v and the hyperedge e;
the membership relationship between the vertex v and the hyperedge e is as follows:
$$h ( v , e ) = \{ \begin{matrix}1 , & if v ∈ e \\ 0 , & others\end{matrix} \qquad ( 1 )$$
wherein in Equation (1), v∈e denotes that the vertex is on the hyperedge, D_{τ,v}=[d(v)] is a degree matrix of the vertex v under the time slice τ, which is used to describe an importance of the vertex v in a hypergraph G_{τ} at a current moment, and d(v) is a sum of weights of all hyperedges connected to the vertex v, which is calculated from Equation (2):
$$d ( v ) = {\sum }_{e ∈ E} ω ( e ) h ( v , e ) \qquad ( 2 )$$
where D_{τ,e}=[d(e)] is a degree matrix of the hyperedge e under the time slice τ, which is used to describe an importance of the hyperedge e in the hypergraph G_{τ} under the time slice τ, and d(e) is a total number of all the vertexes connected by the hyperedge e, which is calculated from Equation (3):
$$d ( e ) = {\sum }_{v ∈ V} h ( v , e ) . \qquad ( 3 )$$

4. The group categorizing method based on dynamic hypergraph clustering of individual mobility patterns according to claim 1, wherein the constructing the mobility pattern-based dynamic hypergraph clustering model comprises:
learning the deep representation of the individual mobility pattern by using a Transformer model;
learning the deep representation of the neighborhood group mobility pattern in the local space by using the hypergraph convolutional network model;
fusing the individual mobility pattern and the neighborhood group mobility pattern to perform dynamic hypergraph deep clustering; and
training and testing the mobility pattern-based dynamic hypergraph clustering model.

5. The group categorizing method based on dynamic hypergraph clustering of individual mobility patterns according to claim 4, wherein the learning the deep representation of the individual mobility pattern by using the Transformer model comprises:
autonomously learning a deep representation C^{(l)} of the individual mobility pattern from an individual mobility pattern feature matrix X at an l-^{th} (1≤l≤L) convolutional layer through an operating principle of a multi-head attention mechanism of a built-in encoder of the Transformer model, wherein C^{(l)} is calculated from Equation (4):
$$\{ \begin{matrix}\begin{matrix}{C}^{( l )} = {σ}_{ReLU} ( Transformer ( {C}^{( l - 1 )} ) ) = \\ LN ( dropout ( FeedForward ( {Res}^{( l )} ) + {Res}^{( l )} ) )\end{matrix} \\ FeedForward ( {Res}^{( l )} ) = max ( 0 , {Res}^{( l )} {U}_{1} + {b}_{1} ) {U}_{2} + {b}_{1} \\ {Res}^{( l )} = L N ( MultiHead ( {C}^{( l - 1 )} ) + {C}^{( l - 1 )} )\end{matrix} , \qquad ( 4 )$$
where σ_{ReLU} is a linear activation function, when l=1, C^{(l-1)}=C⁰ is the individual mobility pattern feature matrix X, LN is a regularization operation of a convolutional layer, dropout is an operation of randomly pruning a fully-connected layer, FeedForward is a fully-connected network, Res^{(l)} is a residual unit of a decoder of the Transformer model, U₁ and U₂ are weight parameters to be trained of the model, b₁ and b₂ are bias values, and MultiHead is the multi-head attention mechanism;
by using a built-in decoder in the Transformer model, obtaining reconstructed \tilde{X} through processing of L convolutional layers, thereby completing a decoding operation;
minimizing an average reconstruction error [symbol] _{transformer} to obtain the deep representation of the individual mobility pattern which is closest to a real situation, where ∥⋅∥_{Fro} is F norm, wherein the average reconstruction error is generated in a process of encoding and decoding, and an expression for the average reconstruction error [symbol] _{transformer} is shown in Equation (5):
$${ℒ}_{transformer} = \frac{1}{T} \frac{1}{N} {\sum }_{T} {\sum }_{N} {‖ {X}_{τ} - \text{?} ‖}_{Fro}^{2} ; \qquad ( 5 )$$
for any time slice τ, calculating a true probability distribution that an individual i belongs to a category j according to a distribution situation of the feature matrix X_{τ} and a real group category to which each individual belongs in the feature matrix X_{τ}, and then acquiring a probability distribution curve GT of individual mobility pattern categories under the time slice τ in a real scenario;
acquiring a probability distribution curve TR of individual mobility pattern categories predicted by the Transformer under the time slice τ based on a distribution situation of the deep representation C^{(L)} of the individual mobility pattern at an L-^{th} convolutional layer;
determining a cumulative error [symbol] _{GT-TR} of the probability distribution curve GT and the probability distribution curve TR across all time slices, and determining a group categorization error after temporal feature learning with the Transformer, wherein [symbol] _{GT-TR} is calculated from Equation (6):
$${ℒ}_{G T - T R} = KL ( GT \vert \vert TR ) = {\sum }_{τ} {\sum }_{i} {\sum }_{j} {GT}_{ij} log \frac{G {T}_{τ ij}}{{TR}_{τ ij}} , \qquad ( 6 )$$
where GT_{τij} refers to a probability that the individual i in the curve GT under the time slice τ belongs to the category j, TR_{τij} refers to a probability that the individual i in the curve TR under the time slice τ belongs to the category j, and KL is “Kullback-Leibler divergence” distribution curve.

6. The group categorizing method based on dynamic hypergraph clustering of individual mobility patterns according to claim 4, wherein the learning the deep representation of the neighborhood group mobility pattern in the local space by using the hypergraph convolutional network model comprises:
performing a hypergraph convolutional network operation based on the hypergraph G_{τ} and an initial categorizing result of the individual-associated group, and capturing a local spatial topological change of the neighborhood group, wherein for an l-^{th} convolutional layer, the deep representation Z^{(l)} of the neighborhood group mobility pattern is calculated from Equation (7):
$${Z}^{( l )} = HGCN ( {G}_{τ} , {Z}^{( l - 1 )} , {σ}_{ReLU} ) = {σ}_{ReLU} ( {D}_{τ , v}^{- 1 / 2} {H}_{τ} {W}_{τ} {D}_{τ , e}^{- 1} {H}_{τ}^{Transponse} {D}_{τ , v}^{- 1 / 2} {Z}^{( l - 1 )} Θ ) , \qquad ( 7 )$$
where Θ is a convolutional hyperparameter, when l=1, Z^{(l-1)}=Z⁰ is a feature matrix X, and H_{τ}^{Transponse} denotes a transposed matrix of H_{τ}.

7. The group categorizing method based on dynamic hypergraph clustering of individual mobility patterns according to claim 4, wherein the fusing the individual mobility pattern and the neighborhood group mobility pattern to perform dynamic hypergraph deep clustering comprises:
concatenating the deep representation C^{(l)} of the individual mobility pattern and the deep representation Z^{(l)} of the neighborhood mobility pattern through Equation (8) to obtain a concatenation result CZ^{(l)} of C^{(l)} and Z^{(l)} at the l-^{th} convolutional layer, wherein CZ^{(l)}n is a n-^{th} vector sequence of CZ^{(l)};
introducing an attention mechanism to obtain a new representation \tilde{Z}^{(l)} of the neighborhood group mobility pattern at the l-^{th} convolutional layer through Equation (9):
$${CZ}^{( l )} = {C}^{( l )} ⊕ {Z}^{( l )} \qquad ( 8 )$$
$${\tilde{Z}}^{( l )} = Atte ntion ( C {Z}^{( l )} , q ) = {\sum }_{n = 1}^{N} {α}_{n} {CZ}^{{( l )}_{n}} = {\sum }_{n = 1}^{N} \frac{exp ( s ( {CZ}^{{( l )}_{n}} , q ) )}{{\sum }_{n = 1}^{N} exp ( s ( {CZ}^{{( l )}_{n}} , q ) )} {CZ}^{{( l )}_{n}} \qquad ( 9 )$$
where q is a query vector, αₙ is an attention weight of a n-^{th} element,
$${\sum }_{n = 1}^{N} {α}_{n} = 1 ,$$
s(CZ^{(l)}n,q) is an attention scoring function, which is used to measure similarity between CZ^{(l)}ₙ and the query vector q, and is expressed quantitatively by a dot product model;
based on a distribution situation of \tilde{Z}^{(l)}, capturing a hypergraph topological structure change ΔG_{τ} under the interaction of the forward time propagation and the backward time propagation, which is the hypergraph topological structure change belonging to either the first or the second hypergraph, but not belonging to both, wherein the hypergraph topological structure change is calculated by Equation (10):
$$Δ {G}_{τ} = difference ( {G}_{1 \to τ} , {G}_{T \to τ} ) = ( {G}_{1 \to τ} ⋃ {G}_{T \to τ} ) - ( {G}_{1 \to τ} ∩ {G}_{T \to τ} ) \qquad ( 10 )$$
dynamically updating a corresponding hypergraph G_{τ} based on G_{τ} and ΔG_{τ}, which serves as an input of the hypergraph convolutional network at a convolutional layer l+1, and performing attention fusion with a corresponding output result C^{(l-1)} from Transformer at an (l+1)-^{th} layer, and executing a hypergraph convolutional network operation to obtain a probability distribution result \tilde{Z}^{(l+1)} of group categories at the (l+1)-^{th} to L-^{th} convolutional layers,
$${\tilde{Z}}^{( l + 1 )} = H G C N ( {G}_{τ} ⊕ Δ {G}_{τ} , {\tilde{Z}}^{( l )} , {σ}_{softmax} ) = {σ}_{softmax} ( {D}_{τ , v}^{′ 1 / 2} {H}_{τ}^{′} {W}_{τ}^{′} {D}_{τ , e}^{′ - 1} {H}_{τ}^{′ Transponse} {D}_{τ , v}^{′ - 1 / 2} {\tilde{Z}}^{( l )} Θ ) \qquad ( 11 )$$
$$where {W}_{τ}^{′} , {H}_{τ , v}^{′} , {D}_{τ , v}^{′} and {D}_{τ , e}^{′} ,$$
are a collection of hyperedge weights, an incidence matrix, a vertex degree matrix and a hyperedge degree matrix of a dynamic hypergraph G_{τ}⊕ΔG_{τ}, respectively;
for any time slice τ, acquiring a probability distribution curve HC of the individual mobility pattern categories obtained by hypergraph clustering under the time slice τ based on the distribution situation of the deep representation Z^{(L)} of the individual mobility pattern at the l-^{th} convolutional layer, measuring a cumulation error [symbol] _{GT-HC} of the probability distribution curves HC and the curve GT across all time slices, and measuring a group categorization error of dynamic hypergraph depth clustering that integrates the individual mobility pattern and the neighborhood group mobility pattern, wherein [symbol] _{GT-HC} is calculated from Equation (12):
$${ℒ}_{G T - H C} = KL ( GT \vert \vert HC ) = {\sum }_{τ} {\sum }_{i} {\sum }_{j} {GT}_{ij} log \frac{G {T}_{τ ij}}{H {C}_{τ ij}} , \qquad ( 12 )$$
where HC_{τij} is a probability that the individual i in the curve HC under the time slice τ belongs to the category j.

8. The group categorizing method based on dynamic hypergraph clustering of individual mobility patterns according to claim 4, wherein the training and testing the mobility pattern-based dynamic hypergraph clustering model comprises:
calculating an overall error through the following Equation:
$$ℒ = {γ}_{1} {ℒ}_{transformer} + {γ}_{2} {ℒ}_{G T - T R} + {γ}_{3} {ℒ}_{G T - H C} , \qquad ( 13 )$$
where γ₁, γ₂ and γ₃ are weight coefficients of [symbol] _{transformer}, [symbol] _{GT-TR} and [symbol] _{GT-HC}, respectively;
training the mobility pattern-based dynamic hypergraph clustering model by relying on the feature matrix X of N individual mobility patterns under T time slices, minimizing a cumulative error [symbol] until [symbol] no longer changes to achieve model convergence, thereby completing the training of the model; and
inputting a feature matrix X_{T+1} of N individual mobility patterns under T+1 time slices into a trained model, and determining that the individual-associated group in a test dataset is found.

9. The group categorizing method based on dynamic hypergraph clustering of individual mobility patterns according to claim 1, wherein after completing the training and testing of the model, the method further comprises performing instance verification for categorization of an individual-associated group, which specifically comprises:
inputting a feature matrix
$${X}_{T}^{′}$$
of M individual mobility patterns under T time slices, and finding an individual-associated group in a verification dataset by using the group categorizing method; wherein the group categorizing method is applied to a public transportation passenger card tap-in and tap-out dataset, and performance of the group categorizing method and an internal module thereof are verified by multi-group comparative experiment and ablation experiment.

10. A group categorizing system based on dynamic hypergraph clustering of individual mobility patterns, comprising:
a data acquisition module, configured to acquire a collection of historical travel records of N individuals;
an individual mobility pattern feature matrix extraction module, configured to extract D-dimensional travel features from a historical travel record and to quantitatively express a mobility pattern of each individual;
an individual mobility pattern hypergraph collection construction module, configured to construct a collection of hypergraphs at a current period of time according to a feature matrix of current individual mobility patterns;
an individual mobility pattern deep representation learning module, configured to learn a deep representation of each individual mobility pattern by relying on a Transformer “encoding-decoding” structure;
a neighborhood group mobility pattern deep representation learning module, configured to learn a deep representation of a neighborhood group mobility pattern in a local space by relying on a hypergraph convolutional network model;
a dynamic hypergraph deep clustering module, configured to fuse the deep representations of the individual mobility pattern and the deep representation of the neighborhood group mobility pattern by using an attention mechanism, capture a change value of a hypergraph topological structure under the interaction of forward time propagation and backward time propagation by using a bidirectional hypergraph convolutional network, and update a hypergraph structure dynamically;
a training and testing module, configured to input the collection of historical travel records of N individuals into a mobility pattern-based dynamic hypergraph clustering model for performing training and testing on categorization of an individual-associated group; and
a classification module, configured to input a collection of historical travel records of M individuals into the mobility pattern-based dynamic hypergraph clustering model to obtain travel groups to which the M individuals belong; wherein the travel groups comprise: a group with regular travel times and regular origins and destinations, a group with regular travel times and irregular origins and destinations, a group with irregular travel times and regular origins and destinations, and a group with irregular travel times and irregular origins and destinations;
a dispatching module, configured to:
for first individuals in the group with regular travel times and regular origins and destinations among the M individuals, calculate a proportion of the first individuals appearing at respective stations during respective periods among the M individuals based on the collection of historical travel records; identifying a target period during and a target station at which the proportion exceeds a predetermined proportion; increase a number of public transport vehicles on a basis of existing baseline schedules to allow increased public transport vehicles to stop only at the target station during the target period;
for second individuals in the group with regular travel times and irregular origins and destinations among the M individuals, obtain historical public transportation card tap-in and tap-out data of the second individuals; determine an origin-destination distribution of the second individuals during respective time periods from the historical public transportation card tap-in and tap-out data; based on the origin-destination distribution, determine a first time period and a first public transport route in which a route passenger flow during the first time period drops below its historical average route passenger flow by more than a first flow threshold; determine a second time period and a second public transport route in which a route passenger flow during the second time period exceeds its historical average route passenger flow by more than a second flow threshold; and allocate at least one public transport vehicle from the first public transport route to the second public transport route during an overlapping period of the first time period and second time period; wherein a route passenger flow of a public transport route is a sum of station passenger flows at all stations along the public transport route;
for third individuals in the group with irregular travel times and regular origins and destinations among the M individuals, predict a period, an origin, and a destination such that route passenger flow from the origin to the destination during the period exceeds a third flow threshold; increase a service frequency of public transport between the origin and the destination during the period; and
for fourth individuals in the group with irregular travel times and irregular origins and destinations among the M individuals, determining a gathering area based on a schedule of an event that causes gathering in combination with public transportation card tap-in and tap-out data of the fourth individuals; in response to a number of the fourth individuals gathering in the gathering area exceeding a predetermined number, dispatching individual transport vehicles to an vicinity of the gathering area.
